(19) United States
(12) Patent Application Publication
(10) Pub. No.: US 2008/0121766 A1
(43) Pub. Date: May 29, 2008

(54) Method and Stand for Handling of Liquid Dispensers

(76) Inventor: Kenneth B. Jorgensen, Skagen (DK)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/884,206

(22) PCT Filed: Jan. 4, 2006
(86) PCT No.: PCT/DK06/00003

§ 371 Date: Aug. 22, 2007

(30) Foreign Application Priority Data
Feb. 8, 2005 (DK) PA 2005 00185

(51) Int. Cl. A47G 29/00; B65G 69/00

(52) U.S. Cl. 248/150; 414/800

(57) ABSTRACT

The invention includes a method and a supporting stand for handling liquid dispensers such as e.g. wine cardboard boxes with a drain tap. Packaging in the shape of cardboard boxes with drain tap is used in a still increasing extent for distributing and handling liquids including especially beverages such as juice, beer or wine. It is known that it is often problematic to handle these types of packaging, among other since the drain tap is placed at the bottom of the container, which is problematic, in that a glass or a mug must obviously be placed below the tap in order to fill it with liquid. This problem is relieved by using a supporting stand in which the container can be placed. When the container is placed in the stand it automatically becomes raised to a given height, which makes it easy to place a glass under the drain tap. The stand has also got the advantage that the container can freely be turned around whereby several people placed around a table can easily drain off liquid. In a preferred embodiment the stand can be suspended on a wall, whereby the packaging does not consume table space. The stand can be adjusted in a way ensuring that it can simply be optimized for types of containers with varying physical dimensions. It is furthermore a part of the invention that the container's drain tap is supported whereby the risk of breakdown of the container is strongly decreased.

The invention relates to a method of handling liquid dispensers such as liquids in containers including cardboard boxes with drain tap for beverages such as juice, beer or wine.

The invention furthermore relates to a stand, supporting device or unit for handling liquid dispensers such as liquids in containers including cardboard boxes with a drain tap for beverages such as juice, beer or wine.

Liquid dispensers such as e.g. cardboard boxes for wine with a drain tap are used in a still increasing extent. This results from the fact that this kind of the containers has got many positive characteristics, including that the liquid, e.g. the wine, can be drained off in portions without oxygen supply, since the wine is kept in a plastic bag inside the outer container, which is mostly manufactured from cardboard.

The fact that no oxygen is added to the liquid, which is being drained off means that this form of packaging is appropriate for consumers, who only want a single glass of wine for the dinner. Traditional wine bottles of glass are not appropriate for such a pattern of use, as the quality of the wine quickly changes, when the wine bottle is opened. By draining wine off from a cardboard box with a drain tap the wine will keep its quality for a long time, which is obviously an advantage, if only a single glass of wine is drained off each day.

It has been found, however, that there are some drawbacks connected to the handling of liquid dispensers in the shape of e.g. wine in cardboard boxes with a drain tap.

One of these drawbacks concerns the technique of the packaging, since the drain tap must be placed in the bottom of the cardboard box, since only gravity can be used as a power source for removing the liquid from the cardboard box.

This means that the cardboard boxes must be placed on a table edge, in order to create space for placing a glass under the drain tap for collecting the outflow of liquid. If several people are placed at a dining table this entails a complicated and difficult handling of the liquid draining, where either the persons or the liquid dispenser must be moved around the table.

It is at the same time space-consuming to place the liquid dispenser at the edge of a table. When the liquid dispenser is placed at a table edge it will also easily be exposed to unintended impact from the people sitting at the table. If a person pushes the container onto the floor, and hereby damages the container, liquid might pour out, and hereby destroying the carpet.

Since the container as mentioned is manufactured of cardboard the drain tap is usually vulnerable towards impacts, which is also a drawback of the use of the mentioned types of containers.

It is therefore a purpose of the invention to improve the known method and to manufacture a stand for handling of liquid dispensers.

The object of the invention is achieved by a method of the type stated in the introductory portion of claim 1, which is characterized in that the packaging is placed in means such as one or more mechanical units, which can be suspended on a vertical surface such as a wall or placed on a base with a horizontal surface such as a table.

Hereby it thus becomes possible to use liquid dispensers including cardboard boxes with a drain tap without demand for placing it at a table edge and without risk of tipping over the packaging, and the consumer gets the possibility of being able to hang the container on a wall.

As stated in claim 2 it is furthermore a distinctive feature of the invention that the mechanical unit can be adjusted in such a way that it can retain liquid dispensers such as cardboard boxes for wine of different dimensions.

Hereby it is achieved that the handling of the packaging is made easier no matter the size of the containers.

In claim 3 is stated that it is also a special characteristic of the invention that the mechanical unit is provided with a supporting device for fixing of an inserted liquid dispenser's draining device such as a drain tap.

Hereby it becomes possible to support the drain tap and thereby reduce the risk of it being ripped off the cardboard box.

Further preferred embodiments of the method of the invention are defined in claims 4 through 7.

As mentioned the invention also relates to a supporting device.

This supporting device is characterized in that the device can be adjusted vertically and horizontally according to the dimensions of the cardboard box and fixed in the adjusted dimensions by e.g. fastening of screw thread based means such as screws or nuts, the supporting stand can furthermore be provided with a supporting device for fixing of the liquid dispenser's draining device such as a drain tap.

Hereby the advantage is achieved that the handling of liquid dispensers in the shape of e.g. cardboard boxes for wine with drain tap is simplified no matter the size of the container. Furthermore the advantage is achieved that the drain tap is supported by the supporting stand and thereby the risk of the drain tap being ripped off the container when the tap is activated is decreased.

As stated in claim 9 it is likewise a special characteristic of the invention that the supporting device consists of two parts, an upper part for fixing liquid dispensers and a lower part intended for placement on a horizontal surface such as a table, and where the two parts can be assembled with a snap lock device and where the upper part can rotate freely in the horizontal plane in relation to the lower part.

Hereby the advantage is, among other, achieved that a liquid dispenser, which is placed in the supporting stand can freely be turned around and thereby easily used by people, who are placed around a table, where the stand is e.g. situated on the middle of the table.

Further preferred embodiments of the supporting stand are stated in claim 10.

The invention will now be explained more fully with reference to the drawings, in which:

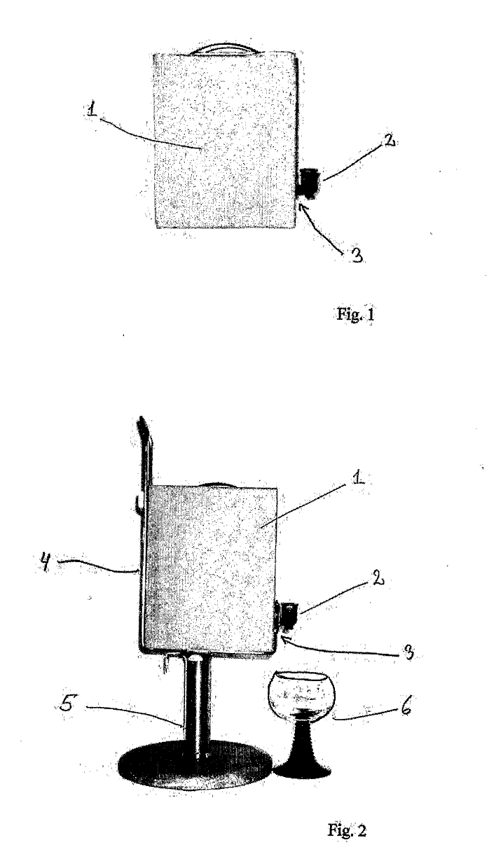

FIG. 1 shows a liquid dispenser included in the present invention.

FIG. 2 shows a liquid dispenser placed in a stand in relation to the invention.

FIG. 3 shows a supporting device for holding a liquid dispenser.

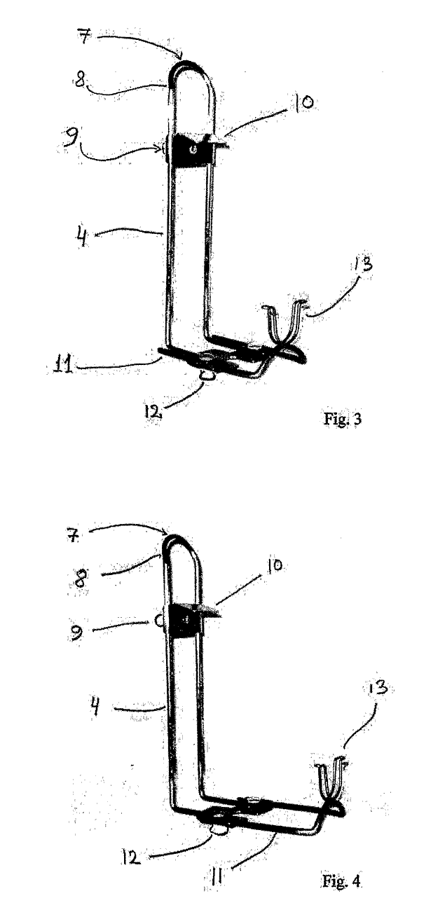

FIG. 4 shows, like FIG. 3, a stand for holding a liquid dispenser, but adapted to a liquid dispenser with another dimension, than the one shown in FIG. 3.

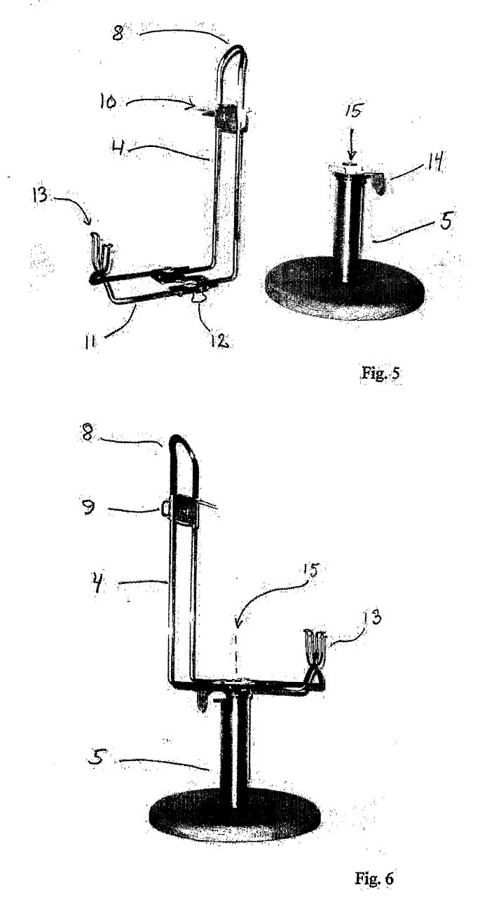

FIG. 5 shows a stand, which consists of two separate parts.

FIG. 6 shows a stand consisting of two parts in assembled state.

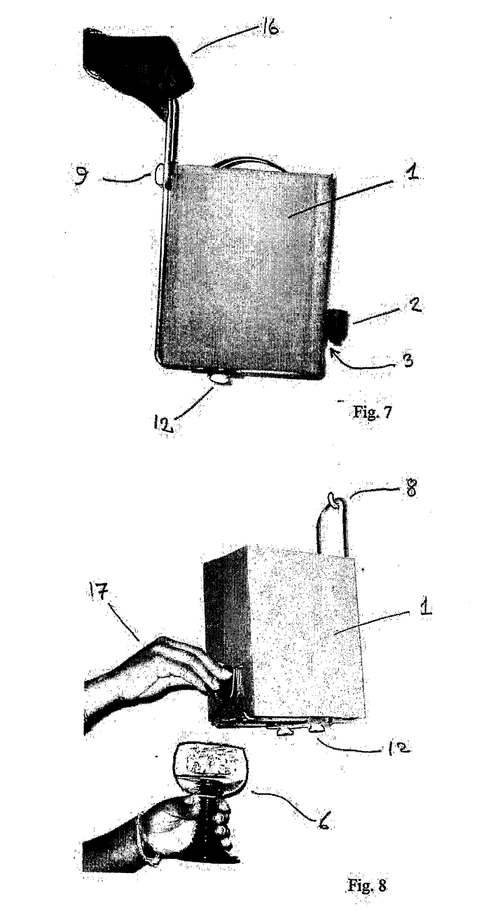

FIG. 7 shows a liquid dispenser placed in a supporting stand, which is used for transport.

FIG. 8 shows the drainage of liquid from a liquid dispenser placed in a stand, which is suspended on a wall.

In FIG. 1 is with 1 shown a liquid dispenser in the shape of a cardboard box for wine with a drain tap 2.

As it will appear from FIG. 1, the drain tap 2 is placed in the bottom of the cardboard box 1, which means that the packaging 1 must be lifted or e.g. placed on the edge of a table top in order to place a glass or a mug under the drain tap 2.

Since the liquid is poured solely by the use of gravity, the drain tap 2 is always placed in the bottom of these types of containers, which means that the problem with getting e.g. a glass placed under the drain tap 2 is generally troublesome for all these types of packaging.

It is therefore often difficult to use these types of containers, since it is space demanding to place them on a table edge and this also increases the risk of the packaging being pushed down on the floor with a subsequent possibility of both the packaging, its content and carpets or other floor covering being destroyed.

Since these types of containers are often made by cardboard the location of the drain tap 2 is often fragile. The fixing of the drain tap 2 in the packaging 1 is often created by a flange part 3, which is to prevent the drain tap 2 from being pushed into the packaging 1.

In FIG. 2 is shown the same type of container, as depicted in FIG. 1, but here the cardboard box 1 has been placed in the upper part 4 of a supporting device, with a lower part 5, which stands on a horizontal surface as e.g. a table top. The lower part 5 has got a height, which ensures that the packaging 1 is lifted to a sufficient height over the table top to enable a glass 6 to be placed under the drain tap 3, whereby draining of the liquid can easily be carried out. The flange part 3, which is a part of the drain tap 2 is supported by a part of the stand 4, which stabilizes the whole drain tap 2 and eases the draining procedure.

FIG. 3 shows the stand part 4, which is provided with a mounting 8, which in the top is shaped in a way so it can easily be fastened on a hook or a screw, which is placed in a vertical surface such as a wall.

In the vertical direction, the stand part 4 is provided with a plate 10, which can be moved up or down the vertical longitudinal direction and is fastened in a given position by activation of the fastening mechanism 9.

The fastening mechanism 9 can e.g. be a threaded finger screw, which locks the position of the plate 10 when it is fastened.

The plate 10 is used to fix the position of an inserted liquid dispenser. This is carried out by positioning the plate 10 on the stand part 4, so that the plate 10, is holding the liquid dispenser in a fixed vertical direction, with an appropriate pressure on the top of the liquid dispenser.

The supporting stand 4 is furthermore provided with an adjustable horizontal lower part 11, which ends with a U shaped holder 13, which is shaped with channels, which can be used for insertion and thereby support of the flange part 3 on drain taps 2, as shown in e.g. FIG. 1 and FIG. 2.

The adjustment of length of the horizontal stand part 11 can be fastened in the desired position by activating the fastening mechanism 12, which can e.g. consist of one or more threaded finger screws. The possibility of adjusting the length of the supporting stand part 11 can be used for adjusting the length so that this exactly matches the length of a given inserted liquid dispenser, which can subsequently be fixed in the stand with an appropriate force of fastening, which is maintained after fastening of the mechanism 12.

In FIG. 4 is shown the stand 4 with the lower part 11 in another position than the one shown in FIG. 3. The example shown in FIG. 4 is thus adjusted to a larger liquid dispenser than the example shown in FIG. 3.

The illustration FIG. 5 shows in a separate state a two-piece stand for insertion and handling of liquid dispensers in the shape of a cardboard box with a drain tap.

The stand part 4 is of the same type as shown in FIG. 3 and FIG. 4, furthermore is shown a stand part 5, which is provided with a circular shaped basis at the bottom, which can be placed on a horizontal plane such as a table and is in the top provided with a part of a snap lock 14, which can turn around a vertical axis of rotation 15.

FIG. 6 shows the two stand parts 4 and 5 in assembled state, where the upper part 4 is identical to the in FIG. 3 and FIG. 4 shown stand parts, which can be adjusted to fasten inserted liquid dispensers of varying size. The lower part 5 and the upper part 4 are assembled using a snap lock mechanism 14 and the upper part 4 can turn freely in the horizontal plane around the axis of rotation 15. The assembly of the two stand parts can with an appropriate selection of snap lock type be carried out without the use of tools.

A liquid dispenser can now be inserted into the supporting stand part 4, in a way like the on shown in FIG. 1, with the flange 3 from the drain tap 2 supported by the stand part 13.

According to FIG. 1, the whole packaging 1 will thus be able to turn around the lower part 5. Hereby several people, who sit around the same table, can easily drain liquid from the liquid dispenser.

FIG. 7 shows a liquid dispenser inserted in the stand part 4, which is transported by the use of a handle 16 in the mounting 8, which is placed in the stand part. The mounting 8 functions as a handle in the situation shown in FIG. 7. The mounting 8 can in this connection be manufactured in such a way, that it is rotatable within a given angle, which is limited such that the handle is optimized in an ergonomic way.

As shown in FIG. 8 the top mounting 8 can also be used for suspending of the stand with inserted liquid dispenser 1 on a vertical surface as e.g. a wall. This has got the advantage that the liquid dispenser will not demand any table space and the suspension can be made in a given height and place, which are ergonomically optimal. The draining of liquid is shown in FIG. 8 by a hand activation 17 of the drain tap, whereby the liquid is poured into the glass 6.

In connection with wall suspension the fastening mechanism 9 can furthermore be shaped in a way, so it also acts to ensure a distance between the stand and a wall.

The invention is not limited to the shown figures and the stated text, but includes all methods and stands for handling of liquid dispensers, which directly or indirectly can be derived from the figures and the text.

1. A method of handling liquid dispensers with a drain tap for beverages comprising placing the packaging in a mechanical unit which can be suspended on a vertical surface or placed on a base with a horizontal surface.

2. A method of handling liquid dispensers according to claim 1, comprising adjusting the mechanical unit so that it can retain liquid dispensers, of different dimensions.

3. A method of handling liquid dispensers according to claim 2, wherein the mechanical unit includes a supporting device for fixing of an inserted liquid dispenser's draining device.

4. A method of handling liquid dispensers according to claim 1, wherein the mechanical unit raises the liquid dispenser above a horizontal plane when it is placed on a horizontal surface.

5. A method of handling liquid dispensers according to claim 1, wherein the mechanical unit includes an upper part for fixing liquid dispensers and a lower part for placement on a base.

6. A method of handling liquid dispenser according to claim 5, wherein the upper part of the unit and the lower part can be assembled and separated without the use of tools, and the upper part of the unit can turn freely in the horizontal plane in relation to the lower part of the unit.

7. A method of handling liquid dispensers according to claim 1, wherein the unit includes a mounting device for suspension on a vertical surface that can also act as a handle.

8. Stand, supporting device or unit for handling liquid dispensers with drain tap for beverages, wherein the stand can be adjusted vertically and horizontally according to the dimensions of the packaging, and fixed in the adjusted dimensions by fastening of screw thread means, the supporting stand can furthermore be provided with a supporting device for fixing of the liquid dispenser's draining device.

9. Stand for handling liquid dispensers according to claim 8, wherein the stand consists of two parts, an upper part for fixing liquid dispensers and a lower part for placement on a horizontal surface, wherein the two parts can be assembled and separated with a snap lock device, and wherein the upper part can rotate freely in a horizontal plane in relation to the lower part.

10. Stand for handling liquid dispensers according to claim 9, wherein the upper part of the stand by the use of a fastening device can be fastened to a hook which is screwn into a vertical surface.
